(19) United States
(12) Patent Application Publication
(10) Pub. No.: US 2025/0323862 A1
(43) Pub. Date: Oct. 16, 2025

(54) High Availability Management Access

(71) Applicant: Arista Networks, Inc., Santa Clara, CA (US)

(72) Inventors: Thejesh Ajjikariappla PANCHAPPA, Newark, CA (US); Vishrant Nitin VASAVADA, Fremont, CA (US); Akshay Kishore GATTANI, Sunnyvale, CA (US)

(21) Appl. No.: 18/759,014

(22) Filed: Jun. 28, 2024

Related U.S. Application Data
(60) Provisional application No. 63/633,656, filed on Apr. 12, 2024.

(51) Int. Cl. H04L 45/28; H04L 43/0829; H04L 45/76

(52) U.S. Cl. CPC H04L 45/28; H04L 43/0829; H04L 45/76

(57) ABSTRACT

The present disclosure provides for path failures on the communication paths that connect the active supervisor on a network device to two or more downstream gateway devices. From a user's point of view, the gateway devices are configured as a single logical gateway node and include a failover mechanism (e.g., using Virtual Router Redundancy Protocol, VRRP) to provide redundant Layer 3 connectivity to the network device. Failover from one gateway device to another happens transparently to the user.

### BACKGROUND

The present disclosure relates to supervisor cards (or simply supervisors) in a network device. A supervisor provides control and management functions for the network device. It is responsible for overseeing the operation of the network device, including managing the forwarding and/or routing of packets and monitoring device performance. The supervisor facilitates communication between different modules within the switch and may offer additional features like redundancy and high availability to ensure uninterrupted network operation.

Management services running on the supervisor can be accessed by the user, such as a network administrator. Access is provided by connecting to physical (management) ports on the supervisor card, such as Ethernet ports. Some network devices are equipped with a single supervisor card, while other network devices have a dual supervisor configuration; an active supervisor and a standby supervisor.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a high level representation of a network device deployed in accordance with the present disclosure.

FIG. 2 is a high level representation of a network device configured in accordance with the present disclosure.

FIG. 3 is a high level representation of supervisor cards configured in accordance with the present disclosure.

FIG. 4 is a high level representation of the active supervisor configured in accordance with the present disclosure.

FIG. 5 is a high level representation of the standby supervisor configured in accordance with the present disclosure.

FIG. 6 is a high level representation of operations to configure the active and standby supervisor cards in accordance with the present disclosure.

FIG. 7 is a high level representation of operations in the active supervisor card in accordance with the present disclosure.

FIG. 8 is a high level representation of a single supervisor configuration in accordance with the present disclosure.

FIG. 9 is a high level representation of a network device having a non-default virtual routing and forwarding (VRF) instance in accordance with the present disclosure.

FIG. 10 is a high level representation of operations to configure a standby supervisor having a non-default VRF instance in accordance with the present disclosure.

FIG. 11 is a high level representation of the standby supervisor having a non-default VRF configured in accordance with the present disclosure.

### DETAILED DESCRIPTION

The present disclosure is directed to providing high availability access to management services in a network device. More specifically, the present disclosure provides for path failures on the communication paths that connect the network device to two or more downstream gateway devices. From a user's point of view, the gateway devices are configured as a single logical gateway node and include a failover mechanism (e.g., using Virtual Router Redundancy Protocol, VRRP) to provide redundant Layer 3 connectivity to the network device. Failover from one gateway device to another happens transparently to the user. A path failure can be a failure of a physical interface, the physical connections to a gateway node, or in a gateway node itself. Embodiments include network device chassis configurations with dual supervisor cards and configurations with single supervisor cards.

Dual-Supervisor Card Configuration with Default VRF Only

In this configuration, the network device includes two supervisor cards, supervisor-1 and supervisor-2. Each supervisor has a path to a gateway node. Initially, supervisor-1 can be set as the active supervisor and supervisor-2 is the backup supervisor. Supervisor-1 can have a path (primary path) to the gateway node, and supervisor-2 can have a path (backup path) to the gateway node. The supervisor cards are connected over an internal path.

In accordance with the present disclosure, the primary path and the internal path are connected to respective physical interfaces (e.g., Ma1/1, int1_1) on supervisor-1. Logical interfaces defined on the physical interfaces can be grouped together as a single logical interface (call it the management active interface, Ma0), for example, using the Linux team utility or the Linux ip utility. A management process running on supervisor-1, can receive and transmit data over Ma0.

Further in accordance with the present disclosure, the backup path and the internal path are connected to respective physical interfaces (e.g., Ma2/1, int2_1) on supervisor-2. Logical interfaces defined on the physical interfaces can be bridged so that traffic received on one interface is bridged to the other interface.

Further in accordance with the present disclosure, the operating state of the primary path and the backup path can be monitored. The “path” in this context includes the interface on the supervisor card to which the physical link is connected, the physical link itself, and the gateway node. In some embodiments, the operating state can be monitored by sending periodic Internet Protocol version 6 Neighbor Solicitation (IPv6 NS) probes to the gateway device and getting a response. If too many replies are missed, the “path” can be deemed to have failed; i.e., one or more elements that constitute the path have failed.

Under normal conditions, a user who is downstream of the gateway node can communicate with an IP bound to the Ma0 interface on supervisor-1 via the primary path between the gateway node and interface Ma1/1.

In response to detecting a failure on the primary path (e.g., too many missed replies to IPv6 probe), the network device will set the logical interface on Ma1/1 to the DOWN state. Ma0 will set the logical interface on Ma2/1 on the backup path as “active” and advertise that Ma0 is reachable via the backup path. The gateway node subsequently starts sending traffic along the backup path. Traffic arrives on interface Ma2/1 on supervisor-2. Because traffic on interface Ma2/2 is bridged to internal interface int2_1, the traffic will be received at internal interface int1_1 on supervisor-1. Because int1_1 is a member of Ma0, the traffic will be forwarded to the Ma0 interface.

Dual-Supervisor Card Configuration with Non-Default VRF

In this configuration, the network device employs a management-specific (non-default) virtual router and forwarding (VRF) instance. Management traffic is processed in accordance with rules in the non-default VRF, while production traffic is processed in accordance with rules in the default VRF. Separating production traffic and management traffic isolates and secures the management functions from attacks in the production traffic.

Supervisor-1 is the active supervisor and is configured as described above. As for supervisor-2, a macvlan interface called mac_ma2_1 is defined on the physical interface Ma2/1 of supervisor-2. The macvlan interface is configured in passthrough mode where packets are processed irrespective of whether the MAC address in the packet matches the macvlan mac_ma2_1 media access control (MAC) address.

A bridge interface Mabr0 is created in the non-default VRF. Both the internal interface int2_1 and the interface Ma2/1 are enslaved by the Mabr0 bridge. Bridging rules are stored in the non-default VRF to process traffic destined to the Ma2/1 MAC address.

In response to detecting a failure on the primary path, the network device will set the logical interface on Ma1/1 to the DOWN state. Ma0 will set the logical interface on Ma2/1 on the backup path as “active” and advertise that Ma0 is reachable via the backup path. The gateway node subsequently starts sending traffic on the backup path. More specifically, Ma2/1 will start receiving packets with destination IP and destination MAC address associated with Ma0. Because the macvlan mac_ma2_1 interface is in passthrough mode, the packet will pass to bridge Mabr0 and will be bridged to internal interface int2_1 and received at internal interface int1_1. Because int1_1 is a member of Ma0, the traffic will be forwarded to the Ma0 interface.

### Single-Supervisor Card Configuration

In this configuration, the network device includes a supervisor card. The supervisor has two paths (primary path, backup path) to a gateway node. Each path is connected to a physical interface on the supervisor; e.g., the primary path is connected to a physical interface Ma1/1 and the backup path is connected to a physical interface Ma1/2.

In accordance with the present disclosure, the logical interfaces defined on the physical interfaces can be grouped together as a single logical interface (call it the management active interface, Ma0), for example, using the Linux team utility or the Linux ip utility. The A management process running on supervisor-1, can receive and transmit data over Ma0. The operational state of the primary path can be monitored by sending periodic IPv6 probes to the gateway node and getting a response.

Under normal conditions, a user who is downstream of the gateway node can communicate with a management process running on the supervisor via the primary path.

In response to detecting a failure on the primary path (e.g., too many missed replies), the network device will set the logical interface on Ma1/1 to the DOWN state. Ma0 will set the logical interface on Ma1/2 on the backup path as “active” and advertise that Ma0 is reachable via the backup path. The downstream gateway devices subsequently start sending traffic on the backup path which is connected to interface Ma1/2. Because the logical interface on Ma1/2 is a member of Ma0, the traffic will be forwarded to the maintenance process.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

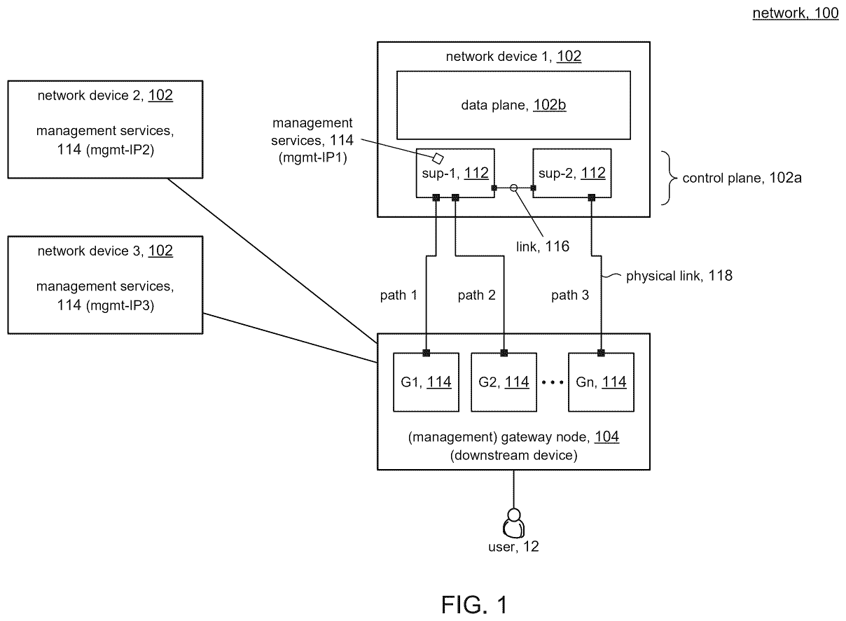

FIG. 1 is a high level diagram illustrating a data network 100 that can embody the techniques in accordance with the present disclosure. In various embodiments, network 100 can comprise network devices 102, such as switches, routers, edge devices, and so on. Gateway node 104 represents a downstream device that can provide a user 12 (e.g., network administrator) with centralized access to management services 114 running on the network devices 102, including for example services such as secured shell (SSH), configuring routing in the network device, configuring the network device for telemetry, and so on. Gateway node 104 can access the management services 114 in a network device 102 via a management Internet Protocol (mgmt-IP) address that is bound to the management services. For example, the management services 114 in network device 1 can be bound to IP address mgmt-IP1, management services in network device 2 can be bound to IP address mgmt-IP2, and so on.

Management services 114 on a network device run in the control plane 102a of the network device 102, while packet switching, packet routing, filtering, and the like occur in the data plane 102b. The control plane 102a in a network device 102 can include one or more supervisor cards 112. In some installments, the network device includes two or more supervisor cards 112, one that is the active supervisor and the other(s) serve as backup supervisors. Management services 114 run on the “active” supervisor 112 (e.g., sup-1 in FIG. 1) while the other (backup) supervisor (e.g., sup-2) runs in “standby mode.” Sup-1 and sup-2 can be connected by an internal link 116 in order to coordinate their actions such as failover processing.

Gateway node 104 is a downstream device that can provide redundant connectivity to each network device 102. FIG. 1, for example, shows multiple communication or data paths between the gateway node 104 and network device 1. Path 1, for example, can be the active or primary path, while path 2 and path 3 serve as backup paths. In accordance with the present disclosure, a communication path comprises (1) the physical link or connection 118 (e.g., Ethernet cable, optical fiber, etc.) between the network device 102 and the gateway node 104, (2) the physical port on the network device to which the physical link is connected, (3) and the gateway node itself.

In some embodiments, for example, gateway node 104 can include two or more gateway devices 114 (G1, G2, . . . . Gn). The gateway devices 114 have physical links or connections to one or more physical ports (interfaces) on one or more supervisors 112 in a network device 102. For example, gateway devices G1 and G2 connect to respective ports on sup-1 in network device 1, and gateway device Gn connects to a port on sup-2 of the network device; likewise for connections network devices 2 and 3. The multiple connections of gateway devices 114 to a network device 102 provide redundant connectivity to the network device 102. The gateway devices 114 can be configured with redundant logical Layer 3 connectivity to the management IP using, for example, the Virtual Router Redundancy Protocol (VRRP).

In accordance with the present disclosure, network device 102 can detect a failure in the communication path to the active supervisor and perform seamless failover connectivity of the management IP to a backup path to maintain uninterrupted communication between gateway node 104 and the active supervisor. In accordance with the present disclosure, a failure in a communication path includes any one or more of (1) a failure in the physical link or connection 118 (e.g., disconnection, damage to the physical cabling, etc.), (2) a failure in the physical port on the network device to which the physical link is connected, (3) and a failure in the gateway node itself (e.g., the gateway device 114 to which the physical link 118 is connected may fail).

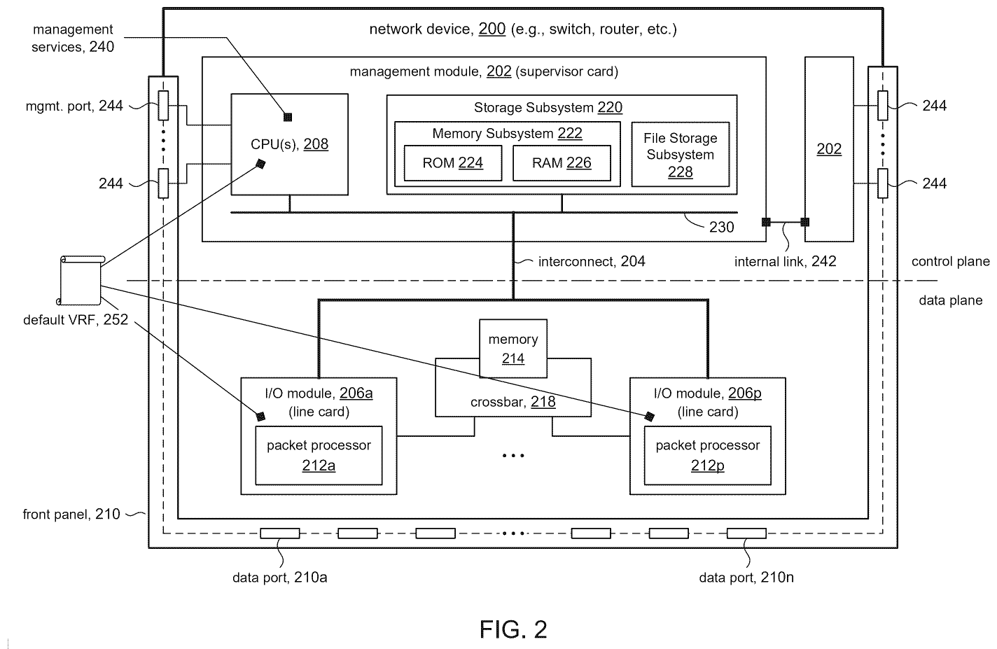

FIG. 2 is a schematic representation of a network device 200 (e.g., a router, switch, firewall, and the like) that can be adapted in accordance with the present disclosure. In some embodiments, for example, network device 200 can include one or more management modules 202 (supervisor cards), one or more I/O modules (line cards, switches, switch chips) 206a-206p, and a front panel 210 of physical data ports 210a-210n. The management modules 202 can be connected by an internal link 242. The management modules 202 can constitute the control plane of network device 200 (also referred to as the control layer or simply the central processing unit, CPU). Each management module can include one or more CPUs 208 for managing and controlling operation of network device 200 in accordance with the present disclosure. CPU(s) 208 can be a general-purpose processor, such as an Intel®/AMD® x86, ARM® microprocessor and the like, that operates under the control of software stored in a memory device/chips such as read-only memory (ROM) 224 or random-access memory (RAM) 226. The control plane provides services that include traffic management functions such as routing, security, load balancing, analysis, and the like.

CPU(s) 208 can communicate with storage subsystem 220 via bus subsystem 230. Other subsystems, such as a network interface subsystem (not shown in FIG. 2), may be on bus subsystem 230. Storage subsystem 220 can include memory subsystem 222 and file/disk storage subsystem 228. Memory subsystem 222 and file/disk storage subsystem 228 represent examples of non-transitory computer-readable storage devices that can store program code and/or data, which when executed by CPU(s) 208, can cause the CPU(s) to perform operations in accordance with embodiments of the present disclosure.

Memory subsystem 222 can include a number of memories such as main RAM 226 (e.g., static RAM, dynamic RAM, etc.) for storage of instructions and data during program execution, and ROM (read-only memory) 224 on which fixed instructions and data can be stored. File storage subsystem 228 can provide persistent (i.e., non-volatile) storage for program and data files, and can include storage technologies such as solid-state drive and/or other types of storage media known in the art.

CPU(s) 208 can run a network operating system stored in storage subsystem 220. A network operating system is a specialized operating system for network device 200. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

In accordance with some embodiments of the present disclosure, management services 240 comprising one or more processes can run on CPU(s) 208 on one of the management modules 202, referred to herein as the active supervisor. The processes that constitute management services 240 can communicate over management ports (e.g., Ethernet interfaces) 244 that can be accessed via the front panel 210. The other management module 202 can run in standby mode.

Bus subsystem 230 can provide a mechanism for the various components and subsystems of management module 202 to communicate with each other as intended. Although bus subsystem 230 is shown schematically as a single bus, alternative embodiments of the bus subsystem can utilize multiple buses.

Just to complete the description of FIG. 2, the one or more I/O modules 206a-206p can be collectively referred to as the data plane of network device 200 (also referred to as the data layer, forwarding plane, etc.). Interconnect 204 represents interconnections between modules in the control plane and modules in the data plane. Interconnect 204 can be any suitable bus architecture such as Peripheral Component Interconnect Express (PCIe), System Management Bus (SMBus), Inter-Integrated Circuit (I²C), etc.

I/O modules 206a-206p can include respective packet processing hardware comprising packet processors 212a-212p (collectively 212) to provide packet processing and forwarding capability. Each I/O module 206a-206p can be further configured to communicate over one or more ports 210a-210n on the front panel 210 to receive and forward network traffic. Packet processors 212 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 212 can include forwarding lookup hardware such as, for example, but not limited to content addressable memory such as ternary CAMs (TCAMs) and auxiliary memory such as static RAM (SRAM).

Memory hardware 214 can include buffers used for queueing packets. I/O modules 206a-206p can access memory hardware 214 via crossbar 218. It is noted that in other embodiments, the memory hardware 214 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The traffic that flows across the management ports 244 can be referred to as management traffic, which is different from the traffic that flows across data ports 210a-210n. The traffic through data ports 210a-210n can be referred to as network or production traffic. Management traffic can refer to traffic that ingresses on the management ports 244. Stated differently, management traffic can refer to traffic whose destination is the active supervisor and services running on that supervisor. Such traffic comprises packets whose destination IP addresses are IP addresses associated with the supervisor and services running on the supervisor. Production traffic refers to traffic other than management traffic. Production traffic can be customer traffic for different applications or services, traffic between customers and end users or tenants, and so on. Management traffic is largely for managing and monitoring the network device.

Network device 200 includes default virtual routing and forwarding (VRF) 252 comprising forwarding and routing tables to process received packets. VRFs are known. Briefly, a VRF instance is a network namespace for L3 networking components, which include among other elements forwarding and routing tables. The forwarding and routing tables in a VRF instance comprise rules to match on ingress packets and actions to perform on matched packets. Rules in turn include: (1) match criteria to match on parts of a packet, such as data fields in the MAC header, TCP header, and so on; and (2) actions such as rewriting parts of the ingress packet, dropping the packet, logging information, and so on.

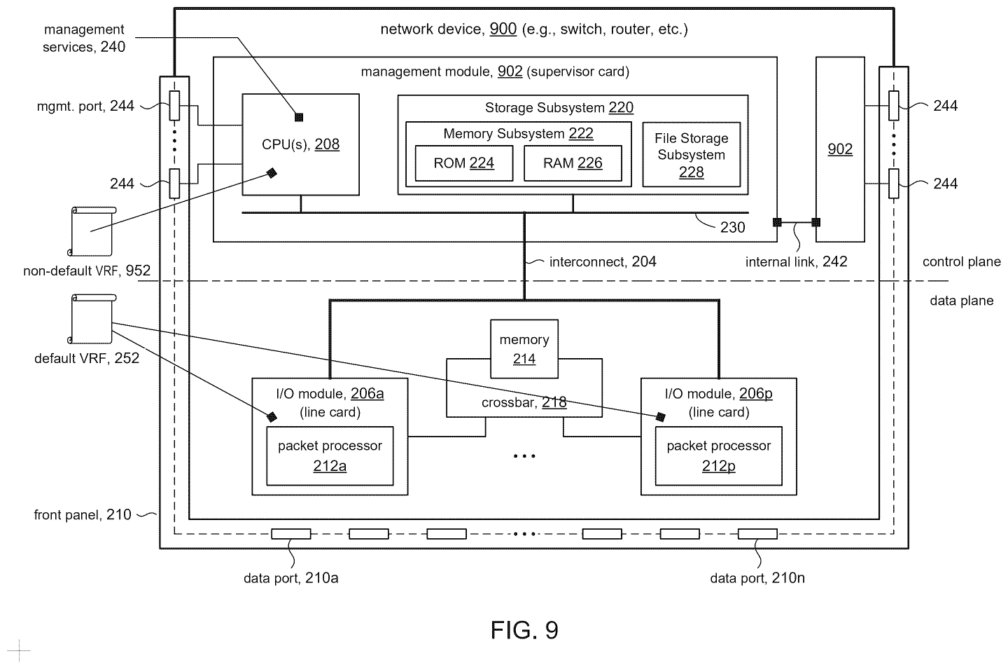

Default VRF 252 can be used in both the I/O modules 206a-206p to process network traffic and in the supervisor cards 202 to process management traffic. In other words, the I/O modules 206a-206p use the default VRF 252 to process network traffic received on their data ports, and likewise the supervisor cards 202 use the default VRF 252 to process management traffic received on their management ports. FIG. 9 shows a dual-VRF configuration comprising a default VRF and a non-default VRF.

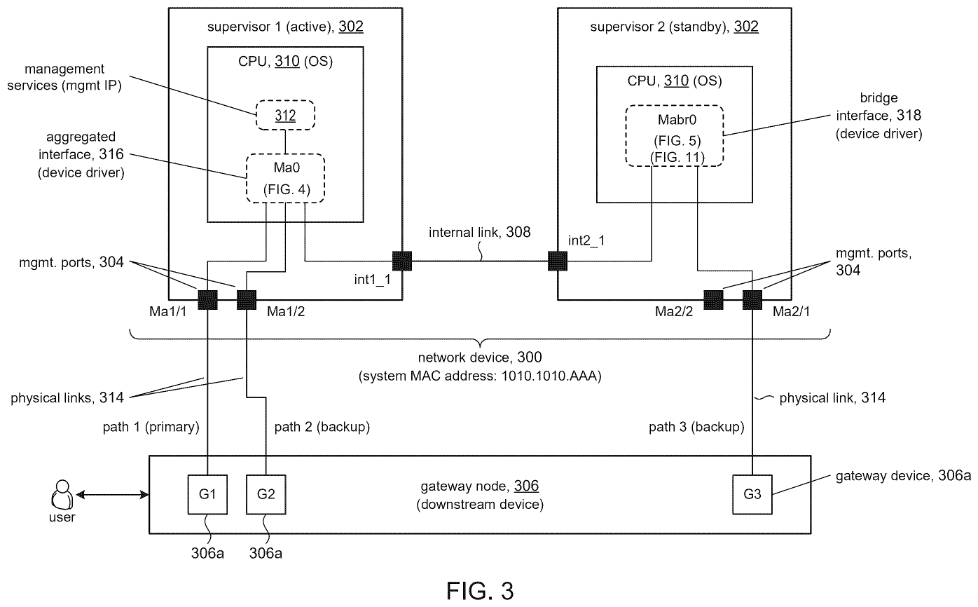

FIG. 3 is an example configuration that illustrates additional details of a network device in accordance with some embodiments. Network device 300 represents an example of a dual-supervisor configuration comprising two supervisor cards 302, supervisor 1 and supervisor 2. Each supervisor 302 includes a CPU 310 running a suitable OS such as Linux, for example.

One supervisor runs as the “active supervisor” and the other supervisor runs in standby mode as the standby supervisor. Each supervisor 302 comprises one or more physical management ports 304 (e.g., Ethernet interfaces). Supervisor 1, for instance, has ports Ma1/1 and Ma1/2, and likewise supervisor 2 has ports Ma2/1 and Ma2/2. The supervisors 302 are connected together by an internal link 308 (e.g., Peripheral Component Interconnect Express, PCIe) that connects an internal physical port int1_1 on supervisor 1 to an internal physical port int2_1 on supervisor 2. This connection allows the supervisors to coordinate failover handling. The data plane components of network device 300 are omitted for clarity.

In accordance with the present disclosure, the active supervisor can define an aggregated interface 316 (e.g., a device driver), referred to herein as management active interface Ma0, that combines (aggregates) management ports Ma1/1, Ma1/2, and internal port int1_1 as redundant ports. Further in accordance with the present disclosure, the standby supervisor can define a bridge interface device driver 318 (Mabr0) that enslaves management port Ma2/1 and internal port int2_1.

FIG. 3 shows a gateway node 306 which represents a downstream device that can provide users with access to management services 312. The example of gateway node 306 shown in the figure comprises three gateway devices 306a, G1, G2, G3, connected to the network device 300. Path 1 comprises a physical link 314 that connects gateway device G1 to physical port Ma1/1 on supervisor 1, path 2 likewise comprises a physical link 314 that connects gateway device G2 to physical port Ma1/2 on supervisor 1, and path 3 connects gateway device G3 to physical port Ma2/1 on supervisor 2. In the example configuration shown in the figure, path 1 is designated the primary path and paths 2 and 3 are designated backup paths.

The active supervisor (e.g., supervisor 1) can instantiate one or more processes that run on CPU 310 to provide various management services 312 for managing the network device 300. The management services 312 can connect to the management active interface Ma0 in order to communicate with gateway node 306.

The management services 312 are bound to an IP address referred to herein as the management IP. Users can access the management services 312 by sending requests via gateway node 306 to the management IP address. Initially, management traffic (requests and responses) between management services 312 and gateway node 306 flow along the primary path 1 (path 1). Probe packets can be transmitted on the primary and backup paths to monitor whether the path is up or down (failed). When a failure is detected along the primary path, but the active supervisor remains operational, failover handling in accordance with the present disclosure will cause management traffic to flow on a suitable backup path (path 2, path 3) to the still-operational active supervisor. In accordance with the present disclosure, management traffic continues to use the management IP address to reach management services 312, but now flows on the backup path instead of the failed primary path. This ability to “float” the management IP address from the primary path to a backup path provides high availability access to the management services 312 in the event of a path failure. These aspects of the present disclosure will now be discussed in more detail.

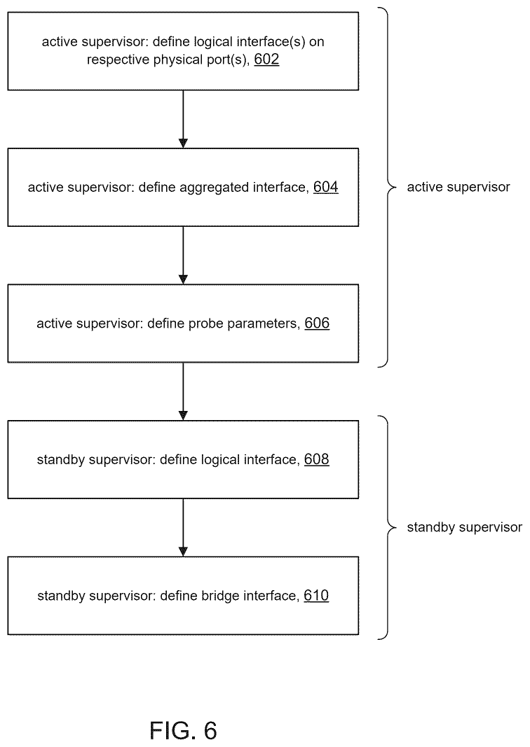

Referring to FIG. 6 and the examples in FIGS. 3, 4, and 5, the discussion will now turn to a high-level description of processing in the supervisor cards (e.g., 302) of a network device (e.g., 300) for configuring the supervisors (active and standby) in accordance with the present disclosure. In some embodiments, each supervisor card can include one or more processing units (circuits), which when operated, can cause the supervisor card to perform processing in accordance with FIG. 6. Processing units (circuits), for example, can include general CPUs that operate by way of executing computer program code stored on a non-volatile computer readable storage medium (e.g., read-only memory); e.g., CPU 208 in the control plane (FIG. 2) can be a general CPU. The operation and processing blocks described below are not necessarily executed in the order shown. Operations can be combined or broken out into smaller operations in various embodiments. Operations can be allocated for execution among one or more concurrently executing processes and/or threads.

### Active Supervisor

At operation 602, the active supervisor can define or otherwise configure one or more logical interfaces on one or more respective physical ports of the supervisor. In accordance with some embodiments, a macvlan interface can be defined on management ports and a VLAN interface can be defined on the internal port. A macvlan is a logical interface that can be created on top of a parent interface with an Ethernet MAC address that is different from the parent interface.

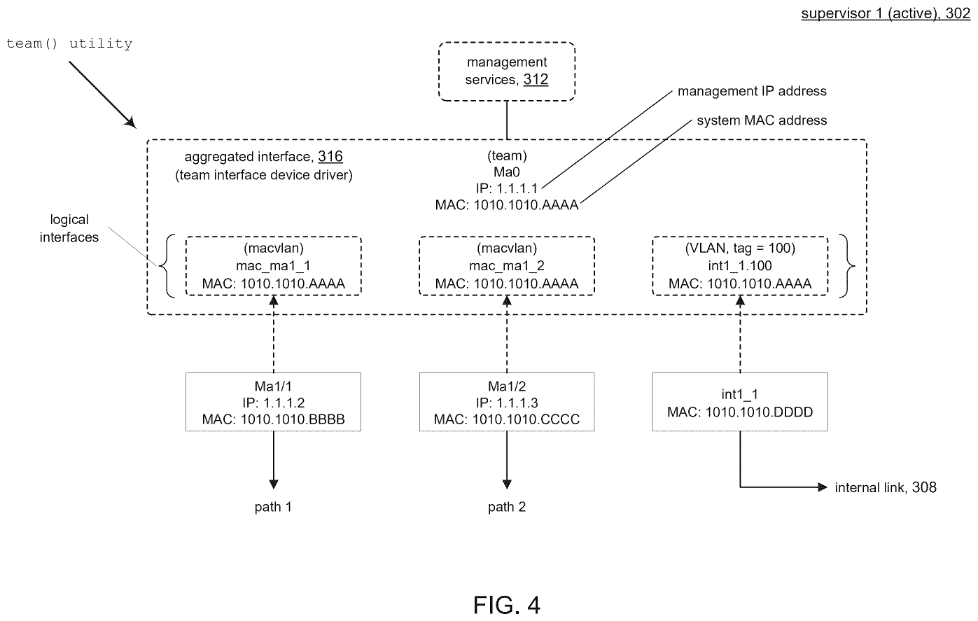

As shown in FIG. 3, supervisor 1 comprises management ports Ma1/1 and Ma1/2 and internal port int1_1. FIG. 4 shows that a macvlan interface named mac_ma1_1 is defined on port Ma1/1, and a macvlan interface named mac_ma1_2 is defined on port Ma1/2. A MAC address can be selected and assigned to the macvlan interfaces. In some embodiments, for example, the network device itself can have its own MAC address, referred to as the system MAC address; e.g., network device 300 has a system MAC address of 1010.1010.AAAA (expressed in hexadecimal notation). In accordance with some embodiments of the present disclosure, each of the configured macvlan interfaces can be assigned to this system MAC address. The example in FIG. 4, for instance, shows the system MAC address of 1010.1010.AAAA is assigned to both macvlan interfaces mac_ma1_1 and mac_ma1_2.

FIG. 4 further shows that a VLAN interface named int1_1.100 is defined on interface port int1_1, and a VLAN tag (e.g. VLAN tag 100) is assigned to int1_1.100. In accordance with the present disclosure, the system MAC address is assigned to the VLAN interface. In some embodiments, VLAN tags are used to identify management traffic.

At operation 604, the active supervisor can define an aggregated interface from the logical interfaces defined at operation 602. In some embodiments where the supervisor card runs the Linux OS, the Linux team utility can be used to aggregate or otherwise combine a set of ports to create a team interface device driver. The example in FIG. 4, for instance, shows that the team utility can be used to create a device driver called the active management interface Ma0. The Ma0 device driver treats mac_ma1_1, mac_ma1_2, and int1_1.100 as port of the team interface. Each of the ports of Ma0 have a priority that determines the failover order when the active port of Ma0 goes down. For example, the port priority order for Ma0 can be:
mac_ma1_1, mac_ma1_2, int1_1.100.
   The highest priority port (mac_ma1_1) can be set to the ACTIVE state, while the remaining ports can be set to a STANDBY state.

In accordance with the present disclosure, the active management interface Ma0 can be assigned the system MAC address, which in our example is 1010.1010.AAAA. In addition, Ma0 can be assigned an IP address, and when the management services 312 are instantiated and connect to Ma0, the assigned IP address is deemed to be bound to the management services and can be referred to as the management IP.

At operation 606, the active supervisor can configure parameters for transmitting probes on each path. As noted above, the up/down condition of the paths can be determined by transmitting probes packets on the paths. In some embodiments, for example, Internet Protocol v6 (IPv6) Neighbor Solicitation messages can be periodically transmitted. The configuration includes specifying an IPv6 neighbor IP address to which the probes are transmitted and from which corresponding reply packets are expected, an interval (transmit period) between probes (e.g., on the order of milliseconds), and a maximum number of missed reply packets. In some embodiments, these parameters can be applied to all paths, and in other embodiments, each path can have its own parameters. This aspect of the present disclosure is further described below.

### Standby Supervisor

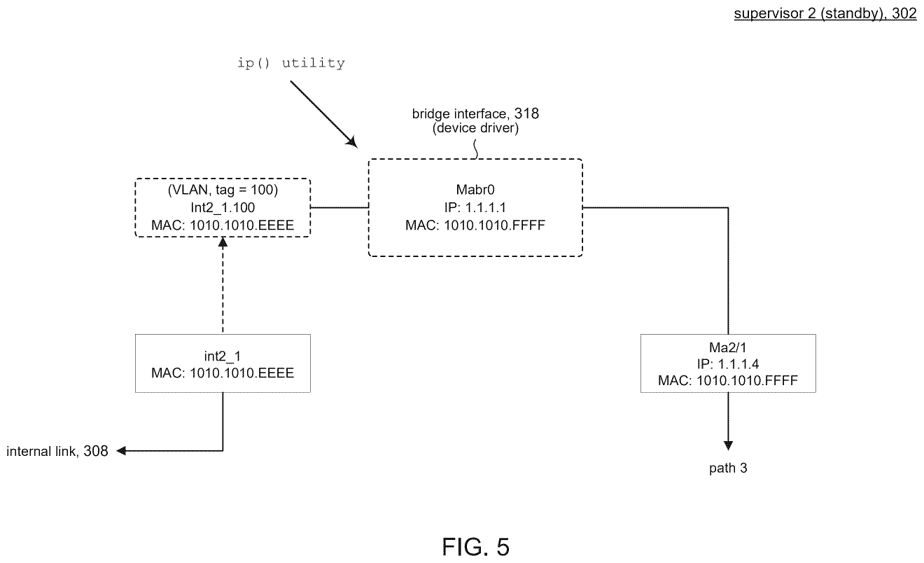

At operation 608, the standby supervisor can define or otherwise configure a VLAN interface on its internal interface. As shown in FIG. 3, standby supervisor 2 comprises internal port int2_1. FIG. 5 shows that a VLAN interface named int2_1.100 is defined on int2_1. The same VLAN tag (e.g., VLAN tag 100) is assigned to int2_1.100 as assigned to int1_1.100 on the active supervisor.

At operation 610, the standby supervisor can create a device driver called a bridge interface to bridge the VLAN interface defined at operation 608 with a management port on the standby supervisor. In some embodiments where the supervisor card runs the Linux OS, the Linux ip utility can be used to create a bridge interface device driver. The example in FIG. 5, for instance, shows that the ip utility can be used to create bridge interface device driver 318 and assign int2_1.100 and Ma2/1 as its bridged ports.

### Failover Processing in a Single VRF Configuration

Referring again to FIGS. 3, 4, and 5, a failover use case in a network device configured in accordance with the present disclosure is described. Assume that the ports in Ma0 are prioritized (highest to lowest) as follows:
mac_ma1_1, mac_ma1_2, int1_1.100.

Stated differently, the path priority is path 1, path 2, path 3. Assume further that the network device is configured with a single VRF. In other words, the network device uses the single (default) VRF to process production traffic and to process management traffic.

Management requests are processed by management services 312 running on the active
supervisor.
G1 transmits packets to physical port Mal/1; the packets have a destination IP set to the
management IP to reach management services 312. The packets reach Mal/1 with
DMAC of mac_mal_1. So the traffic gets assigned to mac_mal_1. Since mac_mal_1 is
enslaved to Ma0, the traffic gets assigned/forwarded to Ma0.

The management service 312 reads the packets at Ma0 and processes the packets accordingly.
When a failure is detected along path 1, Ma0 can set its corresponding port, namely mac_ma1_1, to the DOWN state, and set the next highest priority non-failed port active, namely port mac_ma1_2, to the ACTIVE state. A failed path refers to any one or more of (1) a failure in the physical link or connection 314 (e.g., disconnection, damage to the physical cabling, etc.), (2) a failure in the physical port on the network device to which the physical link is connected, (3) and a failure in the gateway node 306 itself (e.g., a gateway device 306s to which the physical link is connected may fail). Failure detection in a path is discussed below.
In our use case example, Ma0 can set path 2 to be the active path by setting its corresponding port, namely mac_ma1_2, to the ACTIVE state. Ma0 can inform the gateway node 306 to send traffic on path 2, for example, using Gratuitous Address Resolution Protocol (GARP, IPv4) or Unsolicited Neighbor Advertisements (IPv6). In response, gateway node 306 can update its MAC address tables to switch over from G1 to G2.
Note that the active supervisor remains operational, management services continue to be provided by the active supervisor. As such, gateway device G2 continues to send traffic to the management service 312 using the management IP address of the management services. Because the same management IP address is being used, access to the management services is unaffected.
Traffic from G2 reaches port Ma1/2 on path 2. The packets reach Ma1/2 with DMAC of mac_ma1_2, and so the traffic gets assigned to mac_ma1_2. Since mac_ma1_2 is enslaved to Ma0, the traffic gets assigned/forwarded to Ma0.

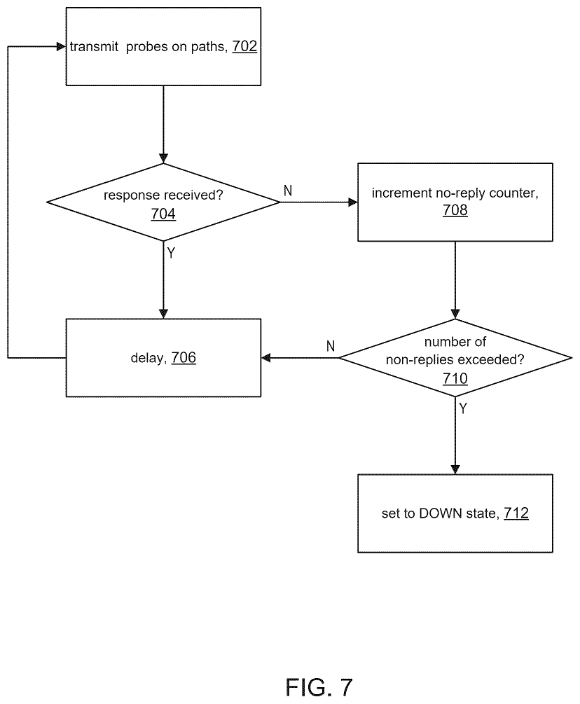

Referring to FIG. 7 and using the example shown in FIGS. 3 and 4, the discussion will now turn to a high-level description of processing in the active supervisor card (e.g., supervisor 1, 302) in a network device (e.g., 300) for configuring the active supervisor to probe each path in accordance with the present disclosure. The operations described below apply to the primary path and each of the backup paths to detect a failure in the path.

At operation 702, the active supervisor can transmit probes on a path connected to the gateway node. In the example shown in FIG. 3, for instance, probes can be transmitted along paths 1, 2, and 3 to constituent gateway devices 306a in gateway node 306. Probes on paths 1 and 2, for example, flow from Ma0 to physical ports Ma1/1, Ma1/2 and are transmitted on respective physical links 314 to respective gateway devices G1, G2. Probes on path 3 flow from Ma0 to internal port int1_1, egress across link 308, ingress on internal port int2_1 in the backup supervisor, and are bridged to physical port Ma2/1 and transmitted on physical link 314 to gateway device G3. In some embodiments, the probes can be IPv6 Neighbor Solicitation (NS) messages.

At decision point 704, the active supervisor can determine whether a probe response is received. In some embodiments, for example, each gateway device can respond to the IPv6 NS probe with an IPv6 Neighbor Advertisement (NA) message. If the gateway device does respond with an IPv6 NA message, then processing can continue at operation 706. If the gateway device does not respond with an IPv6 NA message, then processing can continue at operation 708.

At operation 706, the active supervisor can delay for a period of time (transmit period) before transmitting the next probe. In some embodiments, for example, the transmit period can be set as part of configuring the active supervisor (operation 606, FIG. 6). Processing can return to operation 702 to transmit the next probe.

At operation 708, the active supervisor can increment a no-reply counter that is associated with the path when a reply to a probe is not received.

At decision point 710, if the number of non-replies on a given path exceeds a pre-configured threshold value for the given path (e.g., maximum number of missed reply packets, operation 606), then the path can be deemed to have failed. Processing can proceed to operation 712, otherwise processing can proceed to operation 706.

At operation 712, the active supervisor can set the Ma0 port associated with the physical port to which the failed path is connected to the DOWN state.

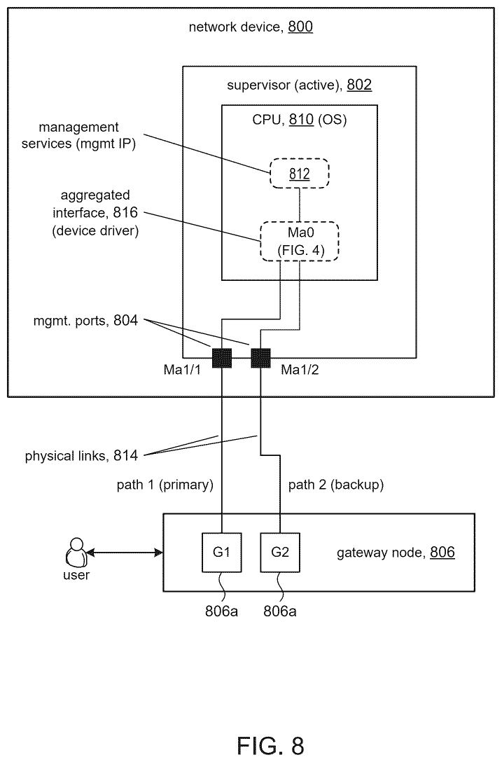

FIG. 8 is an example configuration that illustrates a network device in accordance with some embodiments. Network device 800 represents an example of a single-supervisor configuration comprising only one supervisor card 802. The supervisor card 802 is configured the same as supervisor 1 in FIG. 3, but absent the internal interface int1_1. For example, supervisor 802 comprises a CPU 810 that runs a suitable OS such as Linux, for example. The supervisor 802 further comprises two or more physical management ports 804 (e.g., Ethernet interfaces); e.g., Ma1/1, Ma1/2.

In accordance with the present disclosure, the supervisor 802 can define an aggregated interface 816 (e.g., a device driver), referred to herein as management active interface Ma0, that combines (aggregates) management ports Ma1/1 and Ma1/2 as redundant ports.

FIG. 8 shows a gateway node 806 which represents a downstream device that can provide users with access to management services 812. The example of gateway node 806 shown in the figure comprises gateway devices 806a, G1, G2, connected to the network device 800. Path 1 comprises a physical link 814 that connects gateway device G1 to physical port Ma1/1, and path 2 likewise comprises a physical link 814 that connects gateway device G2 to physical port Ma1/2. In the example configuration shown in the figure, path 1 is designated the primary path and path 2 is designated the backup path.

The active supervisor (e.g., supervisor 1) can instantiate one or more processes that run on CPU 810 to provide various management services 812 for managing the network device 800. The management services 812 can connect to the management active interface Ma0 in order to communicate with gateway node 806.

The management services 812 are bound to an IP address referred to herein as the management IP. Users can access the management services 812 by sending requests via gateway node 806 to the management IP address. Initially, management traffic (requests and responses) between management services 812 and gateway node 806 flow along the primary path 1 (path 1). Probe packets can be transmitted on the primary and backup paths to monitor whether the path is up or down (failed). When a failure is detected along the primary path, but the active supervisor remains operational, failover handling in accordance with the present disclosure will cause management traffic to flow on a suitable backup path (path 2). In accordance with the present disclosure, management traffic continues to use the management IP address to reach management services 812, but now flows on the backup path instead of the failed primary path. This ability to “float” the management IP address from the primary path to a backup path provides high availability access to the management services 812 in the event of a path failure. Operation of the single-card configuration is the same as described above in connection with FIGS. 4, 6, and 7.

### Default and Non-Default VRFs (Dual VRFs)

The foregoing descriptions describe embodiments of network devices that use a single common VRF, referred to as a default VRF to process (1) packets in the network traffic in the data plane and (2) packets in the management traffic in the supervisor cards in the control plane. In some deployments, the user may want to process the management traffic and the production traffic in separate network namespaces or virtual routing and forwarding instances (VRFs) to secure the management traffic from attacks. More specifically, the user may want to be able to attach the management ports on the supervisor cards to a user-defined (non-default) VRF.

### Dual-Supervisor, Dual-VRF Configuration

Embodiments of the present disclosure that use a non-default VRF will now be described in connection with network device 900 shown in FIG. 9. Network device 900 is based on network device 200 shown in FIG. 2. Elements that are common to FIG. 2 and FIG. 9 will be identified with FIG. 2 reference numerals.

Network device 900 includes a non-default VRF 952 in addition to the default VRF 252. I/O modules 206a-206p in network device 900 use the default VRF 252 to process packets that constitute the network traffic, whereas supervisor cards 902 use the non-default VRF 952, instead of the default VRF 252, to process management traffic received on their management ports.

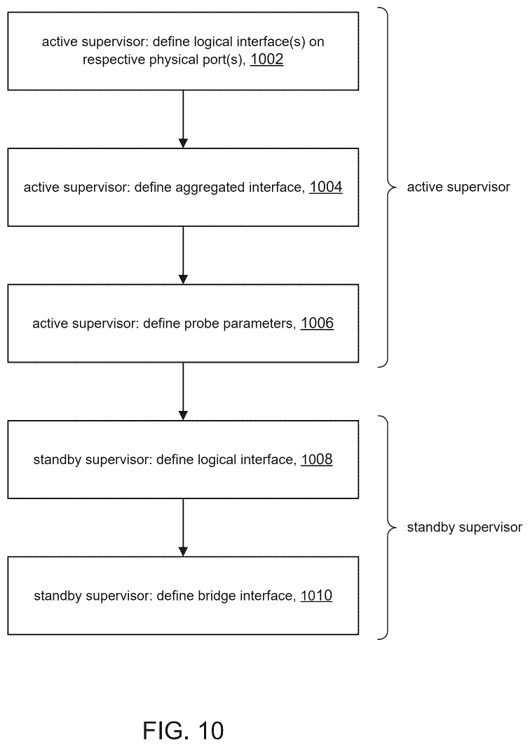

Referring to FIG. 10 and the examples in FIGS. 3 and 4, the discussion will now turn to a high-level description of processing in the supervisor cards (e.g., 902) of a dual-VRF network device (e.g., 900) for configuring the supervisors (one is deemed “active” and the other is deemed “standby”) in accordance with the present disclosure.

At operation 1002, the active supervisor can define or otherwise configure one or more logical interfaces on one or more respective physical ports of the supervisor. Processing is the same as operation 602 in FIG. 6. The details in FIGS. 3 and 4 in connection with supervisor 1 apply to the active supervisor in the dual-VRF configuration of network device 900.

At operation 1004, the active supervisor can define an aggregated interface from the logical interfaces defined at operation 1002. Processing is the same as operation 604 in FIG. 6. The details in FIGS. 3 and 4 in connection with supervisor 1 apply to the active supervisor in the dual-VRF configuration of network device 900.

At operation 1006, the active supervisor can configure parameters for transmitting probes on each path. Processing is the same as operation 606 in FIG. 6. The details in FIGS. 3 and 4 in connection with supervisor 1 apply to the active supervisor in the dual-VRF configuration of network device 900.

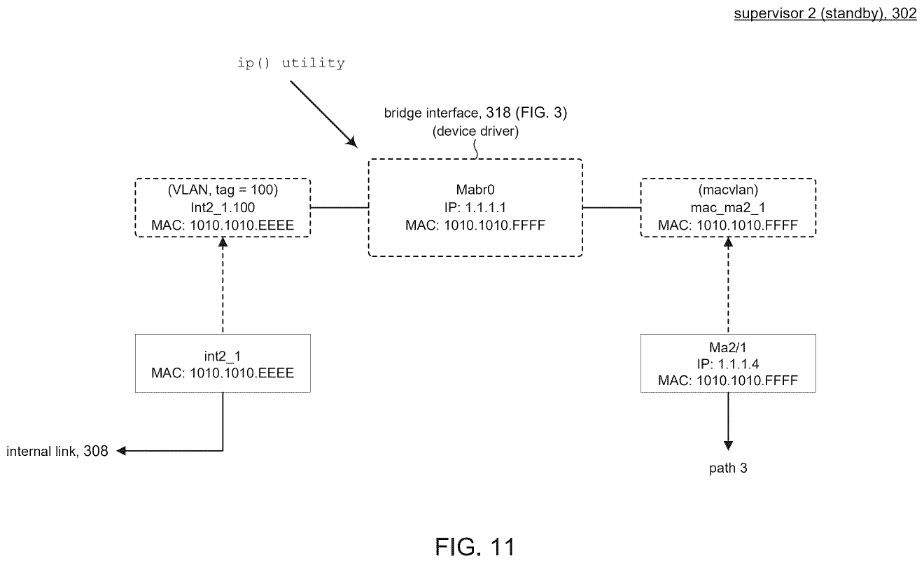

At operation 1008, the standby supervisor can define or otherwise configure one or more logical interfaces on one or more of its physical ports. As shown in FIG. 3, standby supervisor 2 comprises physical port Ma2/1 and internal port int2_1. Detail of the standby supervisor in FIG. 11 shows that a VLAN interface named int2_1.100 is defined on int2_1. The same VLAN tag (e.g., VLAN tag 100) is assigned to int2_1.100 as assigned to int1_1.100 on the active supervisor. FIG. 11 further shows that a macvlan interface named mac_ma2_1 is defined on port Ma2/1. The macvlan interface mac_ma2_1 can be configured in pass-through mode where packets simply pass through without being processed.

At operation 1010, the standby supervisor can create a device driver called a bridge interface to bridge the VLAN interface and the macvlan interface defined at operation 1006. In some embodiments where the supervisor card runs the Linux OS, the Linux ip utility can be used to create a bridge interface device driver. The example in FIG. 11, for instance, shows that the ip utility can be used to create bridge interface device driver 318 and assign int2_1.100 and Ma2/1 as its bridged ports.

### Failover Processing in a Dual VRF Configuration

Referring again to FIGS. 3, 4, and 11, a failover use case in a network device configured in accordance with the present disclosure is described. Assume that the ports in Ma0 are prioritized (highest to lowest) as follows: mac_ma1_1, mac_ma1_2, int1_1.100. Stated differently, the path priority is path 1, path 2, path 3. Assume further that the network device is configured with a custom (non-default) VRF. The network device uses the default VRF to process production traffic and uses the non-default VRF to process management traffic.
Management requests are processed by management services 312 running on the active supervisor.
G1 transmits packets to physical port Ma1/1; the packets have a destination IP set to the management IP to reach management services 312. The packets reach Ma1/1 with DMAC of mac_ma1_1, and so the traffic gets assigned to mac_ma1_1. Since mac_ma1_1 is enslaved to Ma0, the traffic gets assigned/forwarded to Ma0.
The management service 312 reads the packets at Ma0 and processes the packets accordingly.
When a failure is detected along path 1, Ma0 can set its corresponding port, namely mac_ma1_1, to the DOWN state, and set the next highest priority non-failed port active, namely port mac_ma1_2, to the ACTIVE state. As noted above, a failed path refers to any one or more of (1) a failure in the physical link or connection 314 (e.g., disconnection, damage to the physical cabling, etc.), (2) a failure in the physical port on the network device to which the physical link is connected, (3) and a failure in the gateway node 306 itself (e.g., a gateway device 306s to which the physical link is connected may fail).
In our use case example, Ma0 can set path 2 to be the active path by setting its corresponding port to the ACTIVE state. Ma0 can inform the gateway node 306 to send traffic on path 2, for example, using GARP or Unsolicited Neighbor Advertisements. In response, gateway node 306 can update its MAC address tables to switch over from G1 to G2
Note that the active supervisor remains operational, management services continue to be provided by the active supervisor. As such, gateway device G2 continues to send traffic to the management service 312 using the management IP address of the management services. Because the same management IP address is being used, access to the management services is unaffected.
When traffic from G2 reaches port Ma1/2 on path 2. The packets reach Ma1/2 with DMAC of mac_ma1_2, and as such, the traffic gets assigned to mac_ma1_2. Since mac_ma1_2 is enslaved to Ma0, the traffic gets assigned/forwarded to Ma0.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements. embodiments, implementations and equivalents may be employed without departing from the scope of the disclosure as defined by the claims.

1. A method in a network device, the method comprising:
defining first and second logical interfaces, respectively, on a first physical port and a second physical port of a supervisor card of the network device, wherein the first and second physical ports are connected to a gateway node;
defining a management interface by combining the first and second logical interfaces, wherein traffic that ingresses on either the first or second physical port is provided to the management interface;
running a management process, wherein the management process receives traffic from the gateway node via the management interface, wherein traffic from the gateway node initially flows along a first data path, ingresses on the first physical port, is provided to the management interface via the first logical interface, and received by the management process;
periodically transmitting probe packets to the gateway node on the first data path and monitoring for missed response packets to detect occurrence of a failure along the first data path; and
in response to detecting occurrence of a failure along the first data path, advertising that the management interface is reachable on a second data path connected to the second physical port,
wherein the gateway node transmits subsequent traffic to the second physical port in response to the advertising, wherein the subsequent traffic ingresses on the second physical port, is provided to the management interface via the second logical interface, and received by the management process.

2. The method of claim 1, further comprising using a team utility provided by an operating system (OS) running on the network device to combine the first and second logical interfaces to define the maintenance interface.

3. The method of claim 1, wherein the network device is associated with a system MAC address, wherein the first and second logical interfaces are macvlan interfaces, wherein MAC addresses of both macvlan interface are set to the system MAC address, wherein a MAC address of the management interface is set to the system MAC address.

4. The method of claim 1, wherein a failure along the first communication path includes one or more of a failure in the first physical port, a failure in a physical link between the first physical port and the gateway node, and a failure in the gateway node.

5. The method of claim 1, wherein the probe packets are Internet Protocol version 6 (IPv6) Neighbor Solicitation probes, wherein a failure is deemed to have occurred when one or more responses to the IPv6 probes are not received.

6. The method of claim 1, wherein the supervisor card is the only supervisor card in the network device.

7. The method of claim 1, further comprising using Gratuitous Address Resolution Protocol or Unsolicited Neighbor Advertisements to advertise that the management interface is reachable on a second data path connected to the second physical port.

8. A network device comprising a first supervisor card (first supervisor) and a second supervisor card (second supervisor), wherein the first and second internal interfaces are connected by an internal link, wherein:
the first supervisor is configured to define a virtual management interface that uses a physical port and an internal interface of the first supervisor, wherein traffic that ingresses on either the physical port or the internal interface of the first supervisor is provided to the virtual management interface,
the second supervisor is configured to bridge a physical port and an internal interface of the second supervisor, wherein traffic that ingresses on the physical port of the second supervisor is bridged to the internal interface of the second supervisor, wherein the bridged traffic transits the internal link to the internal interface of the first supervisor and is provided to the virtual management interface,
the first supervisor operates in a first configuration, wherein a downstream device transmits traffic along a first data path that ingresses on the physical port of the first supervisor and is provided to the virtual management interface for consumption by a process that reads the virtual management interface, and
the first supervisor operates in a second configuration in response to detecting a failure on the first data path, wherein the first supervisor advertises that the virtual management interface is reachable on a second data path connected to the physical port on the second supervisor,
wherein the downstream device transmits subsequent traffic to the physical port on the second supervisor in response to the advertising, wherein the subsequent traffic:
ingresses on the physical port on the second supervisor,
is bridged to the internal interface on the second supervisor,
transits the internal link to the internal interface of the first supervisor, and
is provided to the virtual management interface for consumption by the process that reads the virtual management interface.

9. The network device of claim 8, wherein the first supervisor card uses a team utility provided by an operating system (OS) running on the first supervisor card to combine the first and second logical interfaces to define the virtual maintenance interface.

10. The network device of claim 8, wherein the first supervisor defines a macvlan interface on its physical port and defines a VLAN Interface on its internal interface, wherein the virtual management interface comprises the macvlan interface and the VLAN interface, wherein the second supervisor defines a VLAN interface on its internal interface.

11. The network device of claim 10, wherein the network device is associated with a system MAC address, wherein a MAC address of the macvlan interface is set to the system MAC address, wherein a MAC address of the management interface is set to the system MAC address.

12. The network device of claim 8, wherein the first supervisor is configured to periodically transmit probe packets to the downstream device on the first data path and monitoring for missed response packets to determine occurrence of a failure along the first data path.

13. The network device of claim 8, wherein a failure along the first data path includes a failure in the first physical port, a failure in a physical link between the first physical port and the downstream device, and a failure in the downstream device.

14. A network device comprising:
a plurality of line cards for receiving and transmitting production traffic, the line cards processing the network traffic according to a first virtual routing and forwarding (VRF) table; and
a first supervisor card (first supervisor) and a second supervisor card (second supervisor) for processing management traffic, the first and second supervisors processing the management traffic according to a second VRF different from the first VRF so that the production traffic and the management traffic are processed separately from each other,
wherein the first and second supervisors are connected together by an internal link,
wherein the first supervisor is configured to define a virtual management interface that uses a physical port and an internal interface of the first supervisor, wherein traffic that ingresses on either the physical port or the internal interface of the first supervisor is provided to the virtual management interface,
wherein the second supervisor is configured to bridge a physical port and an internal interface of the second supervisor, wherein traffic that ingresses on the physical port of the second supervisor is bridged to the internal interface of the second supervisor, wherein the bridged traffic transits the internal link to the internal interface of the first supervisor and is provided to the virtual management interface,
wherein the first supervisor operates in a first configuration wherein a downstream device transmits traffic along a first data path that ingresses on the physical port of the first supervisor and is provided to the virtual management interface for consumption by a management service that reads the virtual management interface, and
wherein the first supervisor operates in a second configuration in response to detecting a failure on the first data path, wherein the first supervisor advertises that the virtual management interface is reachable on a second data path connected to the physical port on the second supervisor,
wherein the downstream device transmits subsequent traffic to the physical port on the second supervisor in response to the advertising, wherein the subsequent traffic:
ingresses on the physical port on the second supervisor,
is bridged to the internal interface on the second supervisor,
transits the internal link to the internal interface of the first supervisor, and
is provided to the virtual management interface for consumption by the process that reads the virtual management interface.

15. The network device of claim 14, wherein the second supervisor is configured to:
define a macvlan interface on its physical port,
define a VLAN interface on its internal interface,
configure the macvlan interface for pass-through mode, and
bridge the macvlan interface and the VLAN interface.

16. The network device of claim 14, wherein the first supervisor card uses a team utility provided by an operating system (OS) running on the first supervisor card to combine the first and second logical interfaces to define the maintenance interface.

17. The network device of claim 14, wherein the first supervisor defines a macvlan interface on its physical port and defines a VLAN Interface on its internal interface, wherein the virtual management interface comprises the macvlan interface and the VLAN interface, wherein the second supervisor defines a VLAN interface on its internal interface.

18. The network device of claim 17, wherein the network device is associated with a system MAC address, wherein a MAC address of the macvlan interface is set to the system MAC address, wherein a MAC address of the management interface is set to the system MAC address.

19. The network device of claim 14, wherein the first supervisor is configured to periodically transmit probe packets to the downstream device on the first data path and monitoring for missed response packets which indicate occurrence of a failure along the first data path.

20. The network device of claim 14, wherein a failure along the first data path includes a failure in the first physical port, a failure in a physical link between the first physical port and the downstream device, and a failure in the downstream device.
